(19) United States
(12) Patent Application Publication
(10) Pub. No.: US 2016/0174553 A1
(43) Pub. Date: Jun. 23, 2016

(54) DISINFECTANT PERACETIC ACID SOLUTIONS

(71) Applicant: Medivators Inc., Minneapolis, MN (US)

(72) Inventors: John J. Matta, Shoreview, MN (US); Tuan Nguyen, Chaska, MN (US)

(21) Appl. No.: 14/578,379

(22) Filed: Dec. 20, 2014

(51) Int. Cl. A01N 37/16

(52) U.S. Cl. CPC A01N 37/16

(57) ABSTRACT

Various embodiments disclosed relate to a composition that includes (or is formed from): (a) hydrogen peroxide; (b) an organic acid; (c) chelator; and (d) surfactant, wherein the composition includes less than about 0.1 wt. % of an anticorrosive agent. Kits that include the composition, as well as methods of using the composition (e.g., as a disinfectant) are provided.

### BACKGROUND

A perfect disinfectant would offer complete and full microbiological sterilization, without harming humans and useful forms of life, be inexpensive, and non-corrosive. However, ideal disinfectants do not exist. Most disinfectants are also, by nature, potentially harmful (even toxic) to humans or animals.

The choice of disinfectant to be used depends on the particular situation. Some disinfectants have a wide spectrum (kill many different types of microorganisms), while others kill a smaller range of disease-causing organisms but are preferred for other properties (they may be non-corrosive, non-toxic, or inexpensive).

### SUMMARY OF THE INVENTION

In various embodiments, the present invention provides for a composition that includes: (a) hydrogen peroxide; (b) organic acid; (c) chelator; and (d) surfactant. The composition includes less than about 0.1 wt. % of an anticorrosive agent. The composition can further optionally include water.

In various embodiments, the present invention provides for a composition that includes: (a) hydrogen peroxide, present in a concentration of about 28 wt. %; (b) acetic acid, present in a concentration of about 16 wt. %; (c) Dequest® 2010, present in a concentration of about 1.0 wt. %; and (d) Pluronic® 10R5 surfactant block copolymer, present in a concentration of about 2.0 wt. %, wherein the composition comprises less than about 0.1 wt. % of an anticorrosive agent. The composition can further optionally include water. In some embodiments, the hydrogen peroxide and acetic acid can combine to form peracetic acid, present in about 6.8-7.5 wt. %.

In various embodiments, the present invention provides for a method of reducing the number of microbes located upon a substrate. In some embodiments, the method includes contacting the substrate with an effective amount of a composition including hydrogen peroxide, organic acid, chelator, and surfactant, wherein the composition comprises less than about 0.1 wt. % of an anticorrosive agent, for a sufficient period of time, effective to reduce the number of microbes located upon the substrate

The present invention also provides for a one part, liquid concentrate disinfectant that includes: (a) about 10-65 wt. % hydrogen peroxide; (b) about 10-65 wt. % of an organic acid; (c) about 0.1-10 wt. % chelator; and (d) about 0.1-8 wt. % surfactant.

The present invention also provides for a one part, liquid concentrate disinfectant composition that includes: (a) about 28 wt. % hydrogen peroxide (b) about 16 wt. % acetic acid; (c) about 1.0 wt. % Dequest® 2010; (d) about 2.0 wt. % Pluronic® 10R5 surfactant block copolymer and (d) about 53 wt. % deionized water. In some embodiments, the disinfectant composition, at equilibrium, includes (a) about 20.0 to about 26.0 wt. % hydrogen peroxide, (b) about 9.0 to about 11.0 wt. % acetic acid, (c) about 1.0 wt. % Dequest® 2010; (d) about 2 wt. % Pluronic® 10R5 surfactant block copolymer (e) about 52.0 to about 62.0 wt. % deionized water and (f) about 6.8 to about 7.5 wt. % peroxyacetic acid.

The present invention also provides for a kit that includes: (a) an enclosed container that includes a removable closure; (b) the composition as described herein, located inside the enclosed container, and (c) printed indicia located on the enclosed container.

The present invention also provides for a method of reducing the number of microbes located upon a substrate. In some embodiments, the method includes contacting the substrate with an effective amount of the composition described herein, for a sufficient period of time, effective to reduce the number of microbes located upon the substrate.

The present invention also provides for a method of killing or inhibiting a microorganism. In some embodiments, the method includes contacting the microorganism with an antimicrobially effective amount of the composition described herein, for a sufficient period of time, effective to kill or inhibit the microorganism.

The present invention also provides for a method of disinfecting a substrate. In some embodiments, the method includes contacting the substrate with an effective amount of the composition described herein, for a sufficient period of time, effective to disinfect the substrate. The present invention also provides for a method of disinfecting a medical device. In some embodiments, the present invention also provides for a method of disinfecting an endoscopic device.

### DETAILED DESCRIPTION OF THE INVENTION

Reference will now be made in detail to certain claims of the present invention, examples of which are illustrated in the accompanying structures and formulas. While the disclosed present invention will be described in conjunction with the enumerated claims, it will be understood that the disclosed present invention is not intended to limit those claims. On the contrary, the disclosed present invention is intended to cover all alternatives, modifications, and equivalents, which can be included within the scope of the present invention, as defined by the claims.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” should be interpreted to include not only the explicitly recited amount of about 0.1 wt. % to about 5 wt. %, but also the individual concentrations (e.g., 1%, 2%, 3%, and 4%) and the sub-ranges (e.g., 0.5%, 1.1%, 2.2%, 3.3%, and 4.4%) within the indicated range.

When describing the present invention, the following terms have the following meanings, unless otherwise indicated.

The term “about” can allow for a degree of variability in a value or range, for example, within 10%, within 5%, or within 1% of a stated value or of a stated limit of a range.

The term “room temperature” as used herein refers to a temperature of about 15° C. to 28° C.

The term “hydrogen peroxide” or “H₂O₂” refers to the compound chemically designated as dihydrogen dioxide, having the CAS Reg. No. 7722-84-1. In specific embodiments of the invention, the hydrogen peroxide includes water. In further specific embodiments of the invention, the hydrogen peroxide is 35% wt. % hydrogen peroxide in water. The hydrogen peroxide can be present in the composition, in any suitable and effective amount.

The term “organic acid” refers to an organic compound with acidic properties. The most common organic acids are the carboxylic acids, whose acidity is associated with their carboxyl group —COOH. Sulfonic acids, containing the group —SO₂OH, are relatively stronger acids. The relative stability of the conjugate base of the acid determines its acidity. Other groups can also confer acidity, usually weakly: —OH, —SH, the enol group, and the phenol group. Organic compounds containing these groups are generally referred to as organic acids. An example of an organic acid is acetic acid.

The term “acetic acid” or “ethanoic acid” refers to an organic compound with the chemical formula CH₃CO₂H (also written as CH₃COOH), having the CAS Reg. No. 64-19-7.

The term “glacial acetic acid” refers to undiluted and relatively concentrated, water-free (anhydrous) acetic acid.

The term “peracetic acid,” “peroxyacetic acid,” or “PAA” refers to an organic compound with the chemical formula CH₃CO₃H.

The term “chelator,” “chelant” or “chelating agent” refers to a compound that forms soluble, complex molecules with certain metal ions, inactivating the metal ions (or to some extent, countering the effects of the metal ions), so that they cannot normally react with other compounds, elements or ions. In specific embodiments, the chelator effectively chelates transition metals. One suitable chelator is 1-hydroxyethane 1,1-diphosphonic acid. In specific embodiments, the chelator will effectively chelate any transition metals present in any of the components of the composition.

The term “Dequest® 2010” refers to the compound (1-hydroxyethylidene-1,1,-diphosphonic acid, or 1-hydroxyethane 1,1-diphosphonic acid, or HEDP. It has a CAS Reg. No. of 2809-21-4.

The term “anticorrosive agent” or “corrosion inhibitor” refers to a compound that, when added to a liquid or gas, decreases the corrosion rate of a material, typically a metal or an alloy. Suitable anticorrosive agents include, e.g., benzotriazole and sodium dodecyl sulfate (SDS).

The term “benzotriazole” or “BTA” refers to the compound 1H-benzotriazole or 1,2,3-benzotriazole, having the CAS Reg. No. 95-14-7, and the chemical structure shown below:

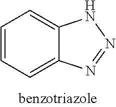

The term “surfactant” refers to a compound capable of lowering the surface tension of a liquid, the interfacial tension between two liquids, or that between a liquid and a solid. Surfactants may act as detergents, wetting agents, emulsifiers, foaming agents, and/or dispersants. The surfactant can be non-ionic, anionic or cationic. Additionally, the surfactant can include one or more non-ionic surfactants, one or more anionic surfactants, and/or one or more cationic surfactants.

The term “non-ionic surfactant” or “nonionic surfactant” refers to a surfactant, in which the total number of electrons is equal to the total number of protons, giving it a net neutral or zero electrical charge. One suitable class of non-ionic surfactants includes the Pluronic® poloxamers.

Poloxamers are nonionic triblock copolymers composed of a central hydrophobic chain of polyoxypropylene (poly(propylene oxide)) flanked by two hydrophilic chains of polyoxyethylene (poly(ethylene oxide)). Poloxamers are also known by the trade name Pluronics®.

Because the lengths of the polymer blocks can be customized, many different poloxamers exist, that have slightly different properties. For the generic term “poloxamer,” these copolymers are commonly named with the letter “P” (for poloxamer) followed by three digits, the first two digits×100 give the approximate molecular mass of the polyoxypropylene core, and the last digit×10 gives the percentage polyoxyethylene content (e.g., P407=Poloxamer with a polyoxypropylene molecular mass of 4,000 g/mol and a 70% polyoxyethylene content). For the Pluronic® tradename, coding of these copolymers starts with a letter to define its physical form at room temperature (L=liquid, P=paste, F=flake (solid)) followed by two or three digits. The first digit (two digits in a three-digit number) in the numerical designation, multiplied by 300, indicates the approximate molecular weight of the hydrophobe; and the last digit×10 gives the percentage polyoxyethylene content (e.g., L61=Pluronic with a polyoxypropylene molecular mass of 1,800 g/mol and a 10% polyoxyethylene content). In the example given, poloxamer 181 (P181)=Pluronic L61.

The term “Pluronic® 10R5 surfactant block copolymer” refers to Polyoxypropylene-polyoxyethylene block copolymer, having the CAS Reg. No. 9003-11-6.

The term “cationic surfactant” refers to a surfactant, in which the total number of electrons is less than the total number of protons, giving it a net positive electrical charge.

The term “anionic surfactant” refers to a surfactant in which the total number of electrons is greater than the total number of protons, giving it a net negative electrical charge. One suitable anionic surfactant is sodium lauryl sulfate.

The term “sodium dodecyl sulfate,” “SDS,” “NaDS,” “sodium lauryl sulfate,” or “SLS” refers to an organic compound with the formula CH₃(CH₂)₁₁OSO₃Na), having the CAS Reg. No. 151-21-3, and the chemical structure shown below:

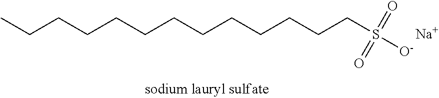 [SMILES: CCCCCCCCCCCCCS(=O)(=O)[O-] ; [Na+]]

The term “room temperature” as used herein refers to a temperature of about 15° C. to 28° C.

The term “disinfectant” refers to a substance that when applied to non-living objects, destroys microorganisms that are living on the objects. The term “disinfect” refers to the process of destruction or prevention of biological contaminants. Disinfection does not necessarily kill all microorganisms, especially nonresistant bacterial spores; it is less effective than sterilization, which is an extreme physical and/or chemical process that kills all types of life.

Disinfectants are different from other antimicrobial agents such as antibiotics, which destroy microorganisms within the body, and antiseptics, which destroy microorganisms on living tissue. Disinfectants are also different from biocides. The latter are intended to destroy all forms of life, not just microorganisms. Sanitizers are substances that simultaneously clean and disinfect.

The term “CFU” refers colony forming units and is a measure of viable cells in which a colony represents an aggregate of cells derived from a single progenitor cell.

The term “EndoHigh® Cleaner” refers to a cleaning composition that includes: (i) chelator that includes ethylenediaminetetraacetic acid (EDTA), present in about 1.0 wt. % of the composition; (ii) buffer system that includes potassium phosphate dibasic and sodium hydroxide, present in about 14.2 wt. % and 2.16 wt. %, respectively, of the composition; (iii) cleaner that includes diethyl glycol monoethyl ether, present in about 5.0 wt. % of the composition; (iv) solubilzer that includes propylene glycol, present in about 10.0 wt. % of the composition; and (v) diluent that includes water, present in about 67.64 wt. % of the composition; wherein the composition has a pH of about 11.9 to about 12.2.

### Disinfecting Composition

In various embodiments, the composition includes: (a) hydrogen peroxide; (b) an organic acid; (c) chelator; and (d) surfactant.

It is appreciated that those of ordinary skill in the art fully understand and appreciate that when a composition includes more than one component, the composition may also include additional components formed as a product of the reaction between the components in the composition. For example, those of skill in the art fully understand and appreciate that a composition including hydrogen peroxide (H₂O₂) and acetic acid (CH₃CO₂H) also includes the oxidized product of acetic acid, peracetic acid (CH₃CO₃H). As such, reference to the composition including hydrogen peroxide (H₂O₂) and acetic acid (CH₃CO₂H) is proper, as well as reference to the composition being formed from hydrogen peroxide (H₂O₂) and acetic acid (CH₃CO₂H). To that end, a composition of acetic acid and hydrogen peroxide will include significant and appreciable amounts of peracetic acid formed from the reaction of aceticic acid with hydrogen peroxide. Further, it is appreciated that those of ordinary skill in the art fully understand and appreciate that an equilibrium exists between hydrogen peroxide and acetic acid, and peracetic acid.

In various embodiments, peracetic acid is present in about 1 wt. % to about 15 wt. % of the composition. In some embodiments, peracetic acid is present in about 2-14 wt. %, 3-12 wt. %, 4-11 wt. %, 5-9 wt. %, about 6-8 wt. %, or about 1 wt. %, 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, or about 15 wt. % or more of the composition. In some embodiments, peracetic acid is present in about 6.8 wt. % to about 7.5 wt. % of the composition.

In various embodiments, hydrogen peroxide is present in about 10 wt. % to about 50 wt. % of the composition. In some embodiments (e.g., before equilibration and formation of PAA), the hydrogen peroxide is present in about 15-45 wt. %, 20-35 wt. %, or about 25-30 wt. % of the composition. In some embodiments (e.g., after equilibration and formation of PAA), the hydrogen peroxide is present in about 10-40 wt. %, 15-35 wt. %, 18-30 wt. % or about 20-26 wt. % of the composition. In some embodiments, the hydrogen peroxide is present in about 16 wt. %, 18 wt. %, 20 wt. %, 21 wt. %, 22 wt. %, 23 wt. %, 24 wt. %, 25 wt. %, 26 wt. %, 27 wt. %, 28 wt. %, 29 wt. %, 30 wt. %, 31 wt. %, 32 wt. %, 34 wt. %, or about 36 wt. %. In some embodiments, the hydrogen peroxide is about 35 wt. % in water, present in about 18 wt. % to about 32 wt. % of the composition. In some embodiments, hydrogen peroxide is about 35 wt. % in water, present in about 28 wt. % of the composition. In some embodiments, hydrogen peroxide is about 35 wt. % in water, present in about 20 wt. % to about 26 wt. % of the composition.

In various embodiments, the organic acid includes acetic acid. In some embodiments, the organic acid comprises glacial acetic acid. In some embodiments, the organic acid includes acetic acid, present in at least about 3 wt. % of the composition. In some embodiments (e.g., before equilibration and formation of PAA), the organic acid includes acetic acid, present in about 1-50 wt. %, 2-45 wt. %, 3-40 wt. %, 4-35 wt. %, 6-30 wt. %, 8-24 wt. %, 10-22 wt. %, 12-20 wt. %, about 14-18 wt. %, or about 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %, 21 wt. %, 22 wt. %, 23 wt. %, 24 wt. %, or about 25 wt. % of the composition. In some embodiments (e.g., after_{—} equilibration and formation of PAA), the organic acid includes acetic acid, present in about 1-20 wt. %, 2-18 wt. %, 3-17 wt. %, 4-16 wt. %, 5-15 wt. %, 6-14 wt. %, 7-13 wt. %, 8-12 wt. %, or about 9-11 wt. % of the composition. In some embodiments, the organic acid includes acetic acid, present in about 9 wt. % to about 11 wt. % of the composition. In some embodiments, the organic acid comprises acetic acid, present in about 16 wt. % of the composition.

In various embodiments, the chelator effectively chelates transition metals. In some embodiments the chelator includes Dequest® 2010 (1-hydroxyethylidene-1,1,-diphosphonic acid, HEDP). In some embodiments, the chelator includes Dequest® 2010 (1-hydroxyethylidene-1,1,-diphosphonic acid, HEDP), present in at least about 0.1 wt. % of the composition. In some embodiments, the chelator includes Dequest® 2010 (1-hydroxyethylidene-1,1,-diphosphonic acid, HEDP), present in about 0.1-10.0 wt. %, 0.2-9.0 wt. %, 0.3-8.0 wt. %, 0.4-7.0 wt. %, 0.5-6.0 wt. %, 0.6-5.0 wt. %, 0.7-4.0 wt. %, about 0.8-2.0 wt. %, or about 0.6 wt. %, 0.8 wt. %, 1.0 wt. %, 1.2 wt. %, or 1.4 wt. % of the composition. In some embodiments the chelator includes Dequest® 2010 (1-hydroxyethylidene-1,1,-diphosphonic acid, HEDP), present in about 1.0 wt. % of the composition.

In various embodiments, the surfactant includes a non-ionic surfactant. In various embodiments, the surfactant includes at least one of an anionic and cationic surfactant. In some embodiments the surfactant includes Pluronic® 10R5 surfactant block copolymer. In some embodiments the surfactant includes Pluronic® 10R5 surfactant block copolymer, present in at least about 0.1 wt. % of the composition. In some embodiments, the surfactant includes Pluronic® 10R5 surfactant block copolymer, present in about 0.1-8.0 wt. %, 0.3-7.0 wt. %, 0.5-6.0 wt. %, 0.7-5.0 wt. %, 0.8-4.0 wt. %, about 1.0-3.0 wt. %, or about 0.5 wt. %, 1.0 wt. %, 1.4 wt. %, 1.8 wt. %, 2.0 wt. %, 2.2 wt. %, 2.6 wt. %, or about 3.0 wt. % of the composition. In some embodiments, the surfactant includes Pluronic® 10R5 surfactant block copolymer, present in about 2 wt. % of the composition.

In various embodiments, the composition includes about 28 wt. % hydrogen peroxide, about 16 wt. % acetic acid, about 1.0 wt. % Dequest® 2010, about 2.0 wt. % Pluronic® 10R5 surfactant block copolymer, and about 53 wt. % deionized water.

In various embodiments, the composition includes about 20.0 to about 26.0 wt. % hydrogen peroxide, about 9.0 to about 11.0 wt. % acetic acid, about 1.0 wt. % Dequest® 2010, about 2.0 wt. % Pluronic® 10R5 surfactant block copolymer, about 53 wt. % deionized water and about 6.8 to about 7.5 wt. % peracetic acid.

In specific embodiments, the composition of the present invention can be formulated as, can exist as, and can be commercially available as a liquid concentrate disinfectant. The term “liquid concentrate” refers to a composition that is relatively undiluted and concentrated, having a low content of carrier, e.g., water. Having the composition be commercially available as a liquid concentrate will typically save costs associated with the manufacturing, shipping, and/or storage of the product.

When the composition of the present invention is formulated as a liquid concentrate, the concentrate can subsequently be diluted with an appropriate amount of carrier (e.g., water) prior to use. Additionally, although considered to be a concentrate, when the composition of the present invention is formulated as a liquid concentrate, a discrete and finite amount of carrier (e.g., water) can be employed.

In various embodiments, the present invention provides for a one part, liquid concentrate disinfectant including about 20.0 about 26.0 wt. % hydrogen peroxide, about 9.0 to about 11.0 wt. % acetic acid, about 1.0 wt. % Dequest® 2010, about 2.0 wt. % Pluronic® 10R5 surfactant block copolymer, about 53 wt. % deionized water and about 6.8 to about 7.5 wt. % peracetic acid.

The composition of the present invention can be formulated for application, depending upon the user's preference as well as the ultimate application of the composition. For example, the composition can be formulated for use in a sprayable composition, atomized liquid sprayer, or liquid applicator. Such formulations can include at least one of a spray bottle, motorized sprayer, wipe, cloth, sponge, non-woven fabric, and woven fabric. Such formulations may be particularly suitable for applying the composition to a surface of a hospital, physician's office, medical clinic, medical facility, dental office, dental facility, airport, school, pet store, zoo, children's day care, elderly nursing home, museum, movie theatre, athletic facility, sporting arena, gymnasium, rest room, bathroom, shopping center, amusement park, church, synagogue, mosque, temple, restaurant, food processing facility, food manufacturing facility, pharmaceutical company, hot-tub, sauna, and/or clean room.

Such liquid formulations may be particularly suitable for applying the composition to metal, plastic, natural rubber, synthetic rubber, glass, stone, grout, fiberglass, wood, concrete, construction products, and/or building products.

In various embodiments, the composition of the invention can be configured for use in contacting at least one of medical equipment, medical device (e.g., reusable medical device or instrument, such as a colonoscope or endoscope), surface in the medical industry, dental equipment, dental device, and surface in the dental industry. In some embodiments, the composition of the invention may be used in the reconditioning of a soiled endoscopic device. In some embodiments, the compositions of the invention are useful during the disinfection step of the cleaning process following use of the endoscope in a medical procedure. The term “endoscopic device” includes a plurality of minimally invasive surgical devices (e.g., scopes) that have been developed for specific uses. For example, upper and lower endoscopes are utilized for accessing the esophagus/stomach and the colon, respectively, angio scopes are utilized for examining blood vessels, and laparoscopes are utilized for examining the peritoneal cavity.

In some embodiments, catalysts for the formation of peracetic acid from hydrogen peroxide and acetic acid are employed. Suitable catalysts include, for example, inorganic acids, such as sulfuric acid (H₂SO₄), hydrochloric acid (HCl), phosphoric acid (H₃PO₄), and nitric acid (HNO₃).

In specific embodiments, the composition of the present invention can be non-corrosive. The term “non-corrosive” or “noncorrosive” refers to a substance that will not destroy or irreversibly damage another surface or substance with which it comes into contact. The main hazards to people include damage to the eyes, the skin, and the tissue under the skin; inhalation or ingestion of a corrosive substance can damage the respiratory and gastrointestinal tracts. Exposure results in chemical burn. Having the composition be relatively non-corrosive will allow the user to employ the composition over a wider range of uses, exposing the composition to a wider range of substrates. For example, having the composition be relatively non-corrosive will allow the user to employ the composition as a disinfectant with certain medical devices that are highly sensitive to corrosive substances.

In specific embodiments, the composition of the present invention can be non-toxic. The term “non-toxic” refers to a substance that has a relatively low degree to which it can damage a living or non-living organism. Toxicity can refer to the effect on a whole organism, such as an animal, bacterium, or plant, as well as the effect on a substructure of the organism, such as a cell (cytotoxicity) or an organ (organotoxicity), such as the liver (hepatotoxicity). A central concept of toxicology is that effects are dose-dependent; even water can lead to water intoxication when taken in large enough doses, whereas for even a very toxic substance such as snake venom there is a dose below which there is no detectable toxic effect. Having the composition be relatively non-toxic will allow a wider range of users be able to safely handle the composition, without serious safety concerns or risks.

In specific embodiments, the composition of the present invention can be stable over extended periods of time (i.e., has a long-term stability). The term “long-term stability” refers to a substance undergoing little or no physical and/or chemical decomposition or degradation, over extended periods of time.

In further specific embodiments, the composition of the present invention can be stable over extended periods of time, such that at about 1 atm and about 19° C., less than about 5 wt. % of each component independently degrades over about one year. In additional specific embodiments, the composition of the present invention can be stable over extended periods of time, such that at about 1 atm and about 19° C., at least about 95 wt. % of each component is independently present after about one year.

Having the composition be relatively stable over extended periods of time will allow the composition to retain its effectiveness over that time, ensuring that it will remain useful and active for its intended purpose. In contrast, in those compositions that do not retain their effectiveness over that time, product loss can result, which can be financially costly. Additionally, risks associated with the use of a product that has lost some or all of its effectiveness for the intended purpose can be hazardous, in that the product may not effectively achieve the desired goal. For example, when used to disinfect a medical device, use of a composition that has lost some or all of its effectiveness as a disinfectant may not effectively disinfect the medical device. Medical injuries can be sustained by the patient, including serious infections.

In specific embodiments, the composition of the present invention can be formulated as, can exist as, and is commercially available as, a one-part composition. The term “one-part composition” refers to all chemical components of a composition being present together, such that they are each in intimate and physical contact with one another, and are each present in a single container. Having the composition be commercially available as a one-part composition will be more cost effective (e.g., lower manufacturing costs associated with fewer containers), and will avoid the necessity of the user mixing or combining multiple components together, prior to using.

In specific embodiments, the composition of the present invention can be essentially free of buffer. In further specific embodiments, the composition of the present invention can include less than about 0.1 wt. % buffer. The term “buffer,” “buffering agent,” or “buffering substance” refers to a weak acid or base used to maintain the acidity (pH) of a solution at a chosen value. The function of a buffering agent is to prevent a rapid change in pH when acids or bases are added to the solution. Buffering agents have variable properties—some are more soluble than others; some are acidic while others are basic.

In specific embodiments, the composition of the present invention can be essentially free of transition metals. In further specific embodiments, the composition of the present invention can include less than about 0.001 wt. % transition metals. In further specific embodiments, the composition of the present invention can include less than about 0.0001 wt. % transition metals. In further specific embodiments, the composition of the present invention can include less than about 0.00001 wt. % transition metals. Having the composition include a minimal amount of transition metals decreases the likelihood that the transition metals will case degradation and/or decomposition of the composition, over the extended periods of time associates with the manufacturing, shipping, and storage of the composition. This is especially so when the composition is formulated as a concentrated, one-part composition.

The term “transition metal,” “transition metals” or “transition element” refers to an element whose atom has an incomplete d sub-shell, or which can give rise to cations with an incomplete d sub-shell. Transition metals include scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (Db), seaborgium (Sg), bohrium (Bh), hassium (Hs) and copernicium (Cn).

In specific embodiments of the invention, the transition metal can be naturally occurring. Naturally occurring transition metals include scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), and mercury (Hg).

In specific embodiments, the composition of the present invention can be essentially free of heavy metals. In further specific embodiments, the composition of the present invention can include less than about 0.001 wt. % heavy metals. In further specific embodiments, the composition of the present invention can include less than about 0.0001 wt. % heavy metals. In further specific embodiments, the composition of the present invention can include less than about 0.00001 wt. % heavy metals. Having the composition include a minimal amount of heavy metals decreases the likelihood that the transition metals will case degradation and/or decomposition of the composition, over the extended periods of time associates with the manufacturing, shipping, and storage of the composition. This is especially so when the composition is formulated as a concentrated, one-part composition.

The term “heavy metal,” “heavy metals” or “toxic metal” refers to metals that are relatively toxic, and mainly include the transition metals, some metalloids, lanthanides, and actinides. Examples of toxic metals include, e.g., iron (Fe), cobalt (Co), copper (Cu), manganese (Mn), molybdenum (Mo), zinc (Zn), mercury (Hg), plutonium (Pu), lead (Pb), vanadium (V), tungsten (W), cadmium (Cd), aluminium (Al), beryllium (Be), and arsenic (As).

The present invention also provides for a kit that includes: (a) an enclosed container that includes a removable closure; (b) the composition of the present invention as described herein, which is located inside the enclosed container; and (c) printed indicia located on the enclosed container.

In specific embodiments, the enclosed container can be opaque. In additional specific embodiments, the enclosed container can be manufactured from high density polyethylene (HDPE), thereby providing the requisite opacity. Having the enclosed container be manufactured from high density polyethylene (HDPE) will decrease the likelihood that the composition will degrade and/or decompose over extended periods of time, due to excessive exposure to direct sunlight.

The term “high-density polyethylene” or “HDPE” refers to a polyethylene thermoplastic made from petroleum. The mass density of high-density polyethylene can range from 0.93 to 0.97 g/cm³. Although the density of HDPE is only marginally higher than that of low-density polyethylene, HDPE has little branching, giving it stronger intermolecular forces and tensile strength than LDPE. The difference in strength exceeds the difference in density, giving HDPE a higher specific strength. It is also harder and more opaque and can withstand somewhat higher temperatures (120° C./248° F. for short periods, 110° C./230° F. continuously). HDPE is resistant to many different solvents.

The term “solvent” as used herein refers to a liquid that can dissolve a solid, liquid, or gas. Non-limiting examples of solvents are silicones, organic compounds, water, alcohols, ionic liquids, and supercritical fluids.

The term “opaque” refers to an object that is neither transparent (allowing all light to pass through) nor translucent (allowing some light to pass through). When light strikes an interface between two substances, in general some may be reflected, some absorbed, some scattered, and the rest transmitted (also see refraction). Reflection can be diffuse, for example light reflecting off a white wall, or specular, for example light reflecting off a mirror. An opaque substance transmits no light, and therefore reflects, scatters, or absorbs all of it. Both mirrors and carbon black are opaque. Opacity depends on the frequency of the light being considered. For instance, some kinds of glass, while transparent in the visual range, are largely opaque to ultraviolet light. More extreme frequency-dependence is visible in the absorption lines of cold gases.

To further decrease the likelihood that the composition will degrade and/or decompose over extended periods of time, the composition should avoid, when feasible: excessive exposure to direct sunlight, excessive heat and/or elevated temperatures. As such, in specific embodiments, the enclosed container of the kit can include printed indicia, with instructions to avoid excessive heat, elevated temperatures, direct sunlight, or a combination thereof.

Over extended periods of time, hydrogen peroxide present in the composition will be susceptible to degrade or decompose (and a portion of the hydrogen peroxide may degrade or decompose), thereby evolving oxygen (O₂), as shown below.

2H₂O₂→2H₂O+O₂

In specific embodiments, the enclosed container includes a head space, pressure valve, or combination thereof. In specific embodiments, the enclosed container includes a pressure valve, configured to release excessive gas from within the enclosed container. The presence of a head space and pressure valve in the container will allow for the escape of gas (e.g., oxygen) from the enclosed container, without the likelihood that the container will explode from the elevated pressure that would otherwise develop.

The term “head space” refers to a portion of the inside of a container that is not occupied by the liquid contents of the container. In particular, when a container includes a liquid composition, a head space can be present in the container such that a portion of the inside of the container does not include liquid composition, but instead includes a gas or vacuum. In specific embodiments, the head space can include oxygen (O₂). In further specific embodiments, the head space can be present in up to about 5% (v/v) of the inside of the enclosed container.

The term “pressure valve” refers to a mechanical device that will permit for the passage of gas and not fluid, preferably in one direction only, for example, exiting a container housing the pressure valve, and not entering the container.

The composition of the present invention can be used to effectively reduce the number of microbes located upon a substrate. In specific embodiments, the composition can effectively kill and/or inhibit a microorganism (e.g., virus, fungus, mold, slime mold, algae, yeast, mushroom and/or bacterium), thereby disinfecting the substrate.

In additional specific embodiments, the composition can effectively sanitize a substrate, thereby simultaneously cleaning and disinfecting the substrate. In additional specific embodiments, the composition can effectively kill or inhibit all forms of life, not just microorganisms, thereby acting as a biocide.

In specific embodiments, the composition can effectively disinfectant a substrate. In further specific embodiments, the composition can effectively disinfectant the surface of a substrate. In additional specific embodiments, the composition can effectively sterilize a substrate. In further specific embodiments, the composition can effectively sterilize the surface of a substrate.

The term “microbe,” “microbes” “microorganism,” or “micro-organism” refers to a microscopic organism that comprises either a single cell (unicellular), cell clusters, or no cell at all (acellular). Microorganisms are very diverse; they include bacteria, fungi, archaea, and protists; microscopic plants (green algae); and animals such as plankton and the planarian. Some microbiologists also include viruses, but others consider these as non-living. Most microorganisms are unicellular (single-celled), but this is not universal, since some multicellular organisms are microscopic, while some unicellular protists and bacteria, like Thiomargarita namibiensis, are macroscopic and visible to the naked eye.

The term “virus” refers to a small infectious agent that can replicate only inside the living cells of organisms. Virus particles (known as virions) consist of two or three parts: the genetic material made from either DNA or RNA, long molecules that carry genetic information; a protein coat that protects these genes; and in some cases an envelope of lipids that surrounds the protein coat when they are outside a cell. The shapes of viruses range from simple helical and icosahedral forms to more complex structures. The average virus is about one one-hundredth the size of the average bacterium. An enormous variety of genomic structures can be seen among viral species; as a group they contain more structural genomic diversity than plants, animals, archaea, or bacteria. There are millions of different types of viruses, although only about 5,000 of them have been described in detail. A virus has either DNA or RNA genes and is called a DNA virus or a RNA virus respectively. The vast majority of viruses have RNA genomes. Plant viruses tend to have single-stranded RNA genomes and bacteriophages tend to have double-stranded DNA genomes.

The term “fungi” or “fungus” refers to a large and diverse group of eucaryotic microorganisms whose cells contain a nucleus, vacuoles, and mitochondria. Fungi include algae, molds, yeasts, mushrooms, and slime molds. See, Biology of Microorganisms, T. Brock and M. Madigan, 6th Ed., 1991, Prentice Hill (Englewood Cliffs, N.J.). Exemplary fungi include Ascomycetes (e.g., Neurospora, Saccharomyces, Morchella), Basidiomycetes (e.g., Amanita, Agaricus), Zygomycetes (e.g., Mucor, Rhizopus), Oomycetes (e.g., Allomyces), and Deuteromycetes (e.g., Penicillium, Aspergillus).

The term “mold” refers to a filamentous fungus, generally a circular colony that may be cottony, wooly, etc. or glabrous, but with filaments not organized into large fruiting bodies, such as mushrooms. See, e.g., Stedman's Medical Dictionary, 25th Ed., Williams & Wilkins, 1990 (Baltimore, Md.). One exemplary mold is the Basidiomycetes called wood-rotting fungi. Two types of wood-rotting fungi are the white rot and the brown rot. An ecological activity of many fungi, especially members of the Basidiomycetes is the decomposition of wood, paper, cloth, and other products derived from natural sources. Basidiomycetes that attack these products are able to utilize cellulose or lignin as carbon and energy sources. Lignin is a complex polymer in which the building blocks are phenolic compounds. It is an important constituent of woody plants. The decomposition of lignin in nature occurs almost exclusively through the agency of these wood-rotting fungi. Brown rot attacks and decomposes the cellulose and the lignin is left unchanged. White rot attacks and decomposes both cellulose and lignin. See, Biology of Microorganisms, T. Brock and M. Madigan, 6th Ed., 1991, Prentice Hill (Englewood Cliffs, N.J.).

The term “slime molds” refers to nonphototrophic eucaryotic microorganisms that have some similarity to both fungi and protozoa. The slime molds can be divided into two groups, the cellular slime molds, whose vegetative forms are composed of single amoebalike cells, and the acellular slime molds, whose vegetive forms are naked masses of protoplasms of indefinite size and shape called plasmodia. Slime molds live primarily on decaying plant matter, such as wood, paper, and cloth. See, Biology of Microorganisms, T. Brock and M. Madigan, 6th Ed., 1991, Prentice Hill (Englewood Cliffs, N.J.).

The term “algae” refers to a large and diverse assemblage of eucaryotic organisms that contain chlorophyll and carry out oxygenic photosynthesis. See, Biology of Microorganisms, T. Brock and M. Madigan, 6th Ed., 1991, Prentice Hill (Englewood Cliffs, N.J.). Exemplary algae include Green Algae (e.g., Chlamydomonas), Euglenids (e.g., Euglena), Golden Brown Algae (e.g., Navicula), Brown Algae (e.g., Laminaria), Dinoflagellates (e.g., Gonyaulax), and Red Algae (e.g., Polisiphonia).

The term “yeast” refers to unicellular fungi, most of which are classified with the Ascomytes. See, Biology of Microorganisms, T. Brock and M. Madigan, 6th Ed., 1991, Prentice Hill (Englewood Cliffs, N.J.).

The term “mushrooms” refer to filamentous fungi that are typically from large structures called fruiting bodies, the edible part of the mushroom. See, Biology of Microorganisms, T. Brock and M. Madigan, 6th Ed., 1991, Prentice Hill (Englewood Cliffs, N.J.).

The term “bacterium” or “bacteria” refers to a large domain of prokaryotic microorganisms. Typically a few micrometers in length, bacteria have a wide range of shapes, ranging from spheres to rods and spirals. Bacteria are present in most habitats on Earth, growing in soil, acidic hot springs, radioactive waste, water, and deep in the Earth's crust, as well as in organic matter and the live bodies of plants and animals, providing outstanding examples of mutualism in the digestive tracts of humans, termites and cockroaches. There are typically about 40 million bacterial cells in a gram of soil and a million bacterial cells in a milliliter of fresh water; in all, there are approximately five nonillion (5×10³⁰) bacteria on Earth, forming a biomass that exceeds that of all plants and animals. Most bacteria have not been characterized, and only about half of the phyla of bacteria have species that can be grown in the laboratory.

The term “P. aeruginosa” or “Pseudomonas aeruginosa” refers to a common bacterium that can cause disease in animals, including humans. It is found in soil, water, skin flora, and most man-made environments throughout the world. It thrives not only in normal atmospheres, but also in hypoxic atmospheres, and has, thus, colonized many natural and artificial environments. It uses a wide range of organic material for food; in animals, the versatility enables the organism to infect damaged tissues or those with reduced immunity. The symptoms of such infections are generalized inflammation and sepsis. If such colonizations occur in critical body organs, such as the lungs, the urinary tract, and kidneys, the results can be fatal. Because it thrives on most surfaces, this bacterium is also found on and in medical equipment, including catheters, causing cross-infections in hospitals and clinics. It is implicated in hot-tub rash.

The term “S. aureus” or “Staphylococcus aureus” refers to a facultative anaerobic Gram-positive bacterium. It is frequently found as part of the normal skin flora on the skin and nasal passages. It is estimated that 20% of the human population are long-term carriers of S. aureus. S. aureus is the most common species of staphylococci to cause Staph infections. The reasons S. aureus is a successful pathogen are a combination host and bacterial immuno-evasive strategies. One of these strategies is the production of carotenoid pigment staphyloxanthin which is responsible for the characteristic golden colour of S. aureus colonies. This pigment acts as a virulence factor, primarily being a bacterial antioxidant which helps the microbe evade the hosts immune system in the form of reactive oxygen species which the host uses to kill pathogens.

S. aureus can cause a range of illnesses from minor skin infections, such as pimples, impetigo, boils (furuncles), cellulitis folliculitis, carbuncles, scalded skin syndrome, and abscesses, to life-threatening diseases such as pneumonia, meningitis, osteomyelitis, endocarditis, toxic shock syndrome (TSS), bacteremia, and sepsis. Its incidence is from skin, soft tissue, respiratory, bone, joint, endovascular to wound infections. It is still one of the five most common causes of nosocomial infections, often causing postsurgical wound infections. Each year, some 500,000 patients in American hospitals contract a staphylococcal infection.

Methicillin-resistant S. aureus, abbreviated MRSA and often pronounced “mer-sa” (in North America), is one of a number of greatly-feared strains of S. aureus which have become resistant to most antibiotics. MRSA strains are most often found associated with institutions such as hospitals, but are becoming increasingly prevalent in community-acquired infections.

The term “E. hirae” or “Enterococcus hirae” refers to a species of Enterococcus.

The term “M. terrae” or “Mycobacterium terrae” refers to a slow-growing species of Mycobacterium. It is an ungrouped member of the third Runyon (nonchromatogenic mycobacteria). It is known to cause serious skin infections, which are relatively resistant to antibiotic therapy

The term “Mycobacterium avium complex,” “M. avium complex” or “MAC” refers to a group of genetically related bacteria belonging to the genus Mycobacterium. It includes Mycobacterium avium and Mycobacterium intracellulare.

The term “M. avium” or “mycobacterium avium” refers to a species of Mycobacterium.

The term “M. intracellulare” or “mycobacterium intracellulare” refers to a species of Mycobacterium.

The invention will now be described by the following non-limiting examples.

### EXAMPLES

Various embodiments of the present invention can be better understood by reference to the following Example which is offered by way of illustration. The present invention is not limited to the Example given herein.

### Example 1

A disinfectant according to the present invention was prepared by mixing hydrogen peroxide (28.0 wt. %), acetic acid (16 wt. %), Dequest® 2010 (1 wt. %), Pluronic® 10R5 surfactant block copolymer (2.0 wt. %), and deionized water (53 wt. %). At equilibrium, the disinfectant had the following concentrations: 20.0-26.0 wt. % hydrogen peroxide, 9.0 to 11.0 wt. % acetic acid, 1.0 wt. % Dequest® 2010, 2.0% wt. % Pluronic® 10R5 surfactant block copolymer, and 6.8 to 7.5 wt. % peracetic acid.

### Example 2

### Preparation of the Endoscopes

Endoscopes were used for standard clinical exams. They were then manually cleaned by the clinic's standard procedure with no extraordinary soil removal.

### Exposure to Test Substance

On a WASSENBURG® WD440 the parameters were adjusted to a 5 minute disinfection cycle with a running temperature of 35±2° C. A disinfectant according to the present invention was prepared from hydrogen peroxide (28.0 wt. %), acetic acid (16 wt. %), Dequest® 2010 (1 wt. %), Pluronic® 10R5 surfactant block copolymer, (2.0 wt. %), and deionized water (53 wt. %) and EndoHigh® Cleaner bottles were connected to the system. The detergent reservoir was filled with EndoHigh® Cleaner solution. The manually cleaned clinical endoscope was inserted into the WD440 and a full cycle was completed. After the full cycle, the lid was opened and the adapters and endoscope were aseptically removed from the machine. The endoscope was aseptically placed in a sterile bin. 150-175 ml of neutralizer (e.g., peptone, sodium thiosulfate, and potassium phosphate and 0.1% tween) was injected into the adapter base to stop the action of residual disinfectant in the endoscope channels. Liquid was collected from the distal tip into a sterile wide-mouth bottle.

### Recovery of Surviving Organisms

The method for eluting the test system from the test article was derived from procedures described by Bond and Hedrick. See W. W. Bond and E. R. Hedrick, 1992. Microbiological Culturing of Environmental and Medical Device Surfaces. In H. D. Isenberg and M. J. R. Gilchrist (eds.), Clinical Microbiological Procedures Handbook, Section 11: Epidemiologic and Infection Control Microbiology, American Society for Microbiology, Washington, D.C., pgs. 11.10.1-11.10.9.

External: 100 ml of neutralizer was dispensed into a sterile wide mouth bottle. Two sterile gauze sponges were moistened with 10 ml of neutralizer. Wearing sterile gloves, the excess neutralizer fluid was squeezed from the sponge and the exterior of the insertion tube was wiped, using 3 back-and-forth strokes across the portion. The sponge was placed into the bottle containing 100 ml of neutralizer. Wiping was repeated with second sponge.

Internal: The distal end of the endoscope was placed in a sterile wide mouth bottle. The biopsy channel was flushed with 100 ml of neutralizer and ≧100 ml of air using a sterile syringe. The air/water channel was flushed with approximately 20 ml neutralizer, followed by approximately 20 ml of air, approximately 10 ml of neutralizer, and approximately 20 ml of air. The auxiliary water channel was flushed with approximately 10 ml neutralizer, approximately 10 ml of air, and approximately 5 ml neutralizer, approximately 10 ml of air. The biopsy channel was brushed with a sterile brush from the control head to the distal tip 5 times. As the brush emerged from the distal tip, the brush tip was ensured to be submerged in the neutralizer to remove any additional adherent organisms. The biopsy channel was then flushed with 45-55 ml of neutralizer and ≧50 ml of air.

The bottles containing the sponges were sonicated for 5 minutes, then swirled for one minute. The contents of all bottles were filtered through 0.22 μm filter and rinsed with two 25-30 ml portions of sterile saline solution. Each filter was placed on TSA and incubated for 37±2° C. for ≧3 days.

The environment during recovery was monitored by using appropriately placed TSA plates and incubated for 37±2° C. for ≧21 days.

### Controls

Neutralizer validation: (1) 1.0 ml of disinfectant was added to 50 ml of neutralizer and mixed. (2) At 5 minutes, 1.0 ml of 1-3×10² CFU/ml cell suspension was added to the neutralizer mix. (3) After 30 minutes, the entire contents were filtered and filters were each placed on TSA. The plates were incubated at 37±2° C. for ≧3 days. Neutralizer toxicity: (1) 1.0 of 1-3×102 CFU/ml cell suspension was added to 50 ml of neutralizer. (2) After 30 minutes, the entire contents were filtered and each filter was placed on TSA. The plates were incubated at 37±2° C. for ≧3 days.

### Results

The following results were obtained:

TABLE 1
Results of clinically used colonoscopes washed and disinfected
by the Wassenburg WD440 using (1) the disinfectant of the present
invention prepared from hydrogen peroxide (28.0 wt. %), acetic acid
(16 w.t %), Dequest ® 2010 (1 wt. %), Pluronic ® 10R5
surfactant block copolymer (2.0 wt. %), and deionized water (53 wt. %)
and (2) EndoHigh ®Cleaner at nominal conditions, 35° C.

| Trial # | Survivors |
|---|---|
| 1 | 0 |
| 2 | 0 |
| 3 | 0 |

TABLE 2
Controls were measured by performing a neutralizer validation to
ensure that the disinfectant was effectively neutralized. The test
organism used was Staphylococcus aureus. Each sample was inoculated
with about 34 CFU. An average of 88.23% of organisms were recovered.

| Sample | CFU Recovered | Percent Recovery |
|---|---|---|
| A | 38 | 111.76 |
| B | 22 | 64.71 |

TABLE 3
Controls were measured by performing a neutralizer toxicity test to
ensure that the neutralizer was not toxic to the test organism. The test
organism used was Staphylococcus aureus. Each sample was
inoculated with about 34 CFU. An average of 91.18% of organisms
were recovered.

| Sample | CFU Recovered | Percent Recovery |
|---|---|---|
| A | 32 | 94.12 |
| B | 30 | 88.24 |

### Conclusions

The disinfectant according to the present invention as described above, EndoHigh® Cleaner, and WASSENBURG® WD440 were capable of washing and high level disinfecting clinically used colonoscopes that have been prewashed using the clinic's standard washing procedure. Further, this met the clinical evaluation report requirements per EU medical device guidance MEDDEV 2.7.1 by achieving the required zero survivors of organisms, and supporting a high level disinfection claim as described in the guidelines for submissions for endoscope washer/disinfectors.

### Example 3

A composition was produced from the following starting materials at the indicated concentrations: (a) hydrogen peroxide, 28.0 wt. %; (b) acetic acid, 16.0 wt. %; (c) Dequest® 2010, 1.0 wt. %; (d) Pluronic® 10R5 surfactant block copolymer, 2.0 wt. %; and (e) deionized water, 53.0 wt. %. At equilibrium, the composition had the following concentrations: (a) hydrogen peroxide, 23.0-27.0 wt. %; (b) acetic acid, 9.0-11.0 wt. %; (c) Dequest® 2010, 1.0 wt. %; (d) Pluronic® 10R5 surfactant block copolymer, 2.0 wt. %; and (e) peracetic acid, 6.0-7.1 wt. %.

The above solution was found to achieve a ≧5 log reduction against mycobacteria (e.g., M. terrae) at 600 ppm (parts per million) of peracetic acid at 35° C., after 5 minutes of contact time. Further, the above solution was found to achieve a ≧5 log reduction against mycobacteria (e.g., M. terrae) at 450 ppm (parts per million) of peracetic acid at 40° C., after 5 minutes of contact time.

### Example 4

### Disinfectant

The disinfectant of the present invention was prepared from hydrogen peroxide (28.0 wt. %), acetic acid (16 wt. %), Dequest® 2010 (1 wt. %), Pluronic® 10R5 (2.0 wt. %), and deionized water (53 wt. %). The disinfectant was aged for longer than 12 months. Prior to use, the disinfectant was diluted to the desired concentration.

### Preparation of Test Organism

A culture of test organisms was prepared by subculturing directly from defrosted cyrovials and streaking out at least 2 plates on Middlebrook 7H10 agar and then incubated at 37±2° C. for ≧21 days. A working culture was prepared by transferring loopfuls of the test culture to a sterile coned bottom screw cap containing 6-7 grams of dry glass beads and homogenize by vortexing for at least 5 minutes. 10 ml of water was added and resuspended by mixing. After 20 minutes of sedimentation, supernatant was transferred to new tube. The optical density was determined with an aliquot of the new suspension at 550 nm. The number of cells was adjusted to 1.5-5.0×10⁷ CFU/ml using water. Population quantity was determined by preparing appropriate dilutions using water. Plated 2 plates per 1.0 ml sample on 7H10 agar and incubated at 37±2° C. for ≧21 days.

### Exposure to Disinfectant

Prior to testing, all reagents were equilibrated to 35±1° C. in a water bath for ≧10 minutes. In a sterile test tube, 1.0 ml of interfering substance (bovine solution) and 1.0 ml of bacterial culture were mixed. Subsequently, the test tube was mixed and placed the tube in 35° C. water bath for 2 minutes. Prior to the end of 2 minutes, the test tube was mixed again. Subsequently, 8.0 ml of the disinfectant was added, the test tube was mixed and placed in 35° C. water bath for 5 minutes. Just before the end of 5 minutes, the test tube was mixed again. At 5 minutes, a 1.0 ml aliquot was removed and transferred to 50 ml of neutralizer PKT+T (i.e. peptone, sodium thio sulfate, KH₂PO₄+Tween 80). The mixture was mixed and allowed to neutralizing for ≧5 minutes. Subsequently, the entire contents were filtered using a Nalgene disposable filter units and rinsed with 50-100 ml of rinsing liquid. The filter was placed on a 7H10 agar plate and incubated at 37±2° C. for ≧21 days. Testing was performed in triplicate.

### Results

The following results were obtained following the above procedure wherein the test organism was M. terrae:

TABLE 4
Microbial testing of disinfectant solution with M. terrae.

| | Inoculum: 1.33 × 107 CFU/mL | | | | |
|---|---|---|---|---|---|
| | | | | | Sample description |
| | 30° C. | | 40° C. | | (dilution in |
| | CFU/ml | | CFU/ml | | reference to |
| Sample | recovered | LOG10 | recovered | Log10 | Pluronic ® 10R5) |
| 1 | TNTC | N/A | 0 | ≧7.12 | 450 ppm |
| | TNTC | N/A | 0 | ≧7.12 | |
| 2 | TNTC | N/A | 0 | ≧7.12 | 500 ppm |
| | TNTC | N/A | 0 | ≧7.12 | |
| 3 | 217 | 4.79 | 0 | ≧7.12 | 600 ppm |
| | 204 | 4.18 | 0 | ≧7.12 | |
| 4 | 16 | 5.92 | 0 | ≧7.12 | 700 ppm |
| | 13 | 6.01 | 0 | ≧7.12 | |
| 5 | 0 | >7.12 | 0 | ≧7.12 | 800 pp, |
| | 3 | 6.65 | 0 | ≧7.12 | |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Enumerated Embodiments

The following enumerated embodiments are provided for further illustration. All combinations and sub-combinations embraced within the enumerated embodiments below are contemplated herein and form part of the presently disclosed subject matter.

[1.] The present invention provides for a composition that includes:

(a) hydrogen peroxide;

(b) organic acid;

(c) chelator; and

(d) surfactant,

wherein the composition comprises less than about 0.1 wt. % of an anticorrosive agent.
[2.] The present invention also provides for a composition that consists essentially of:

(a) hydrogen peroxide;

(b) organic acid;

(c) chelator; and

(d) surfactant,

wherein the composition comprises less than about 0.1 wt. % of an anticorrosive agent.
[3.] The present invention provides for a one part composition that includes:

(a) hydrogen peroxide;

(b) organic acid;

(c) chelator; and

(d) surfactant,

wherein the composition comprises less than about 0.1 wt. % of an anticorrosive agent.
[4.] The present invention also provides for a one part composition that consists essentially of:

(a) hydrogen peroxide;

(b) organic acid;

(c) chelator; and

(d) surfactant,

wherein the composition comprises less than about 0.1 wt. % of an anticorrosive agent.
[5.] The present invention also provides for a composition formed from:

(a) hydrogen peroxide;

(b) organic acid;

(c) chelator; and

(d) surfactant,

wherein the composition comprises less than about 0.1 wt. % of an anticorrosive agent.
[6.] The present invention also provides for the composition of any one of the above embodiments, that further includes peracetic acid.
[7.] The present invention also provides for the composition of any one of the above embodiments, that further includes peracetic acid, formed by the reaction of acetic acid with hydrogen peroxide.
[8.] The present invention also provides for the composition of any one of embodiments [6]-[7], wherein peracetic acid is present in about 1 wt. % to about 15 wt. % of the composition.
[9.] The present invention also provides for the composition of any one of embodiments [6]-[7], wherein peracetic acid is present in about 3 wt. % to about 10 wt. % of the composition.
[10.] The present invention also provides for the composition of any one of embodiments [6]-[7], wherein peracetic acid is present in about 6.8 wt. % to about 7.5 wt. % of the composition.
[11.] The present invention also provides for the composition of any one of the above embodiments, which is a liquid disinfectant.
[12.] The present invention also provides for the composition of any one of the above embodiments, which is non-corrosive.
[13.] The present invention also provides for the composition of any one of the above embodiments, which is non-toxic.
[14.] The present invention also provides for the composition of any one of the above embodiments, having a long-term stability such that at about 1 atm and about 19° C., less than about 5 wt. % of each component independently degrades over about a year.
[15.] The present invention also provides for the composition of any one of the above embodiments, having a long-term stability such that at about 1 atm and about 19° C., at least about 95 wt. % of each component is independently present after about one year.
[16.] The present invention also provides for the composition of any one of the above embodiments, which is essentially free of buffer.
[17.] The present invention also provides for the composition of any one of the above embodiments, comprising less than about 0.1 wt. % buffer.
[18.] The present invention also provides for the composition of any one of the above embodiments, wherein the hydrogen peroxide is present in about 10 wt. % to about 50 wt. % of the composition.
[19.] The present invention also provides for the composition of any one of the above embodiments, wherein the hydrogen peroxide is 35 wt. % in water, present in at least about 15 wt. % of the composition.
[20.] The present invention also provides for the composition of any one of the above embodiments, wherein the hydrogen peroxide is about 35 wt. % in water, present in about 18 wt. % to about 32 wt. % of the composition.
[21.] The present invention also provides for the composition of any one of the above embodiments, wherein the hydrogen peroxide is about 35% wt. % in water, present in about 18 wt. % to about 32 wt. % of the composition.
[22.] The present invention also provides for the composition of any one of the above embodiments, wherein the hydrogen peroxide is about 35 wt. % in water, present in about 20 wt. % to about 26 wt. % of the composition.
[23.] The present invention also provides for the composition of any one of the above embodiments, wherein the hydrogen peroxide is about 35 wt. % in water, present in about 28 wt. % of the composition.
[24.] The present invention also provides for the composition of any one of the above embodiments, wherein the organic acid comprises acetic acid.
[25.] The present invention also provides for the composition of any one of the above embodiments, wherein the organic acid comprises glacial acetic acid.
[26.] The present invention also provides for the composition of any one of the above embodiments, wherein the organic acid comprises acetic acid, present in at least about 3 wt. % of the composition.
[27.] The present invention also provides for the composition of any one of the above embodiments, wherein the organic acid comprises acetic acid, present in about 3 wt. % to 65 wt. % of the composition.
[28.] The present invention also provides for the composition of any one of the above embodiments, wherein the organic acid comprises acetic acid, present in about 7 wt. % to about 14 wt. % of the composition.
[29.] The present invention also provides for the composition of any one of the above embodiments, wherein the organic acid comprises acetic acid, present in about 9 wt. % to about 11 wt. % of the composition.
[30.] The present invention also provides for the composition of any one of the above embodiments, wherein the organic acid comprises acetic acid, present in about 10 wt. % to about 22 wt. % of the composition.
[31.] The present invention also provides for the composition of any one of the above embodiments, wherein the organic acid comprises acetic acid, present in about 16 wt. % of the composition.
[32.] The present invention also provides for the composition of any one of the above embodiments, wherein the chelator effectively chelates transition metals.
[33.] The present invention also provides for the composition of any one of the above embodiments, wherein the chelator comprises Dequest® 2010 (1-hydroxyethylidene-1,1,-diphosphonic acid, HEDP).
[34.] The present invention also provides for the composition of any one of the above embodiments, wherein the chelator comprises Dequest® 2010 (1-hydroxyethylidene-1,1,-diphosphonic acid, HEDP), present in at least about 0.1 wt. % of the composition.
[35.] The present invention also provides for the composition of any one of the above embodiments, wherein the chelator comprises Dequest® 2010 (1-hydroxyethylidene-1,1,-diphosphonic acid, HEDP), present in about 0.1 wt. % to about 10.0 wt. % of the composition.
[36.] The present invention also provides for the composition of any one of the above embodiments, wherein the chelator comprises Dequest® 2010 (1-hydroxyethylidene-1,1,-diphosphonic acid, HEDP), present in about 0.5 wt. % to about 1.5 wt. % of the composition.
[37.] The present invention also provides for the composition of any one of the above embodiments, wherein the chelator comprises Dequest® 2010 (1-hydroxyethylidene-1,1,-diphosphonic acid, HEDP), present in about 1 wt. % of the composition.
[38.] The present invention also provides for the composition of any one of the above embodiments, wherein the surfactant comprises a non-ionic surfactant.
[39.] The present invention also provides for the composition of any one of the above embodiments, wherein the surfactant comprises at least one of an anionic and cationic surfactant.
[40.] The present invention also provides for the composition of any one of the above embodiments, wherein the surfactant comprises Pluronic® 10R5 surfactant block copolymer.
[41.] The present invention also provides for the composition of any one of the above embodiments, wherein the surfactant comprises Pluronic® 10R5 surfactant block copolymer, present in at least about 0.1 wt. % of the composition.
[42.] The present invention also provides for the composition of any one of the above embodiments, wherein the surfactant comprises Pluronic® 10R5 surfactant block copolymer, present in about 0.1 wt. % to about 8 wt. % of the composition.
[43.] The present invention also provides for the composition of any one of the above embodiments, wherein the surfactant comprises Pluronic® 10R5 surfactant block copolymer, present in about 1 wt. % to about 3 wt. % of the composition.
[44.] The present invention also provides for the composition of any one of the above embodiments, wherein the surfactant comprises Pluronic® 10R5 surfactant block copolymer, present in about 2 wt. % of the composition.
[45.] The present invention also provides for the composition of any one of embodiments [1]-[5], wherein:

(a) the hydrogen peroxide is present in a concentration of about 28 wt. %;

(b) the organic acid is acetic acid, present in a concentration of about 16 wt. %;

(c) the chelator is Dequest® 2010, present in a concentration of about 1.0 wt. %; and

(d) the surfactant is Pluronic® 10R5 surfactant block copolymer, present in a concentration of about 2.0 wt. %;

wherein the composition further comprises about 53 wt. % deionized water.

[46.] The present invention also provides for the composition of any one of embodiments [1]-[5], wherein:

(a) the hydrogen peroxide is present in a concentration of about 20-26 wt. %;

(b) the organic acid is acetic acid, present in a concentration of about 9.0 to 11.0 wt. %;

(c) the chelator is Dequest® 2010, present in a concentration of about 1.0 wt. %; and

(d) the surfactant is Pluronic® 10R5 surfactant block copolymer, present in a concentration of about 2.0 wt. %;

wherein the composition further comprise about 53 wt. % deionized water.

wherein the composition further comprises about 6.8 to 7.5 wt. % peracetic acetic acid.

[47.] The present invention also provides for the composition of any one of the above embodiments, wherein the balance (q.s.) of the composition is water.
[48.] The present invention also provides for the composition of any one of the above embodiments, wherein the balance of the composition is deionized water.
[49.] The present invention also provides for the composition of any one of the above embodiments, which is a liquid concentrate disinfectant.
[50.] The present invention also provides for the composition of any one of the above embodiments, formulated for use in a sprayable composition.
[52.] The present invention also provides for the composition of any one of the above embodiments, formulated for use in contacting a surface of at least one of a hospital, physician's office, medical clinic, medical facility, dental office, dental facility, airport, school, pet store, zoo, children's day care, elderly nursing home, museum, movie theatre, athletic facility, sporting arena, gymnasium, rest room, bathroom, shopping center, amusement park, church, synagogue, mosque, temple, restaurant, food processing facility, food manufacturing facility, pharmaceutical company, hot-tub, sauna, and clean room.
[53.] The present invention also provides for the composition of any one of the above embodiments, formulated for use in contacting at least one of metal, plastic, natural rubber, synthetic rubber, glass, stone, grout, fiberglass, wood, concrete, construction product, and building product.
[54.] The present invention also provides for the composition of any one of the above embodiments, formulated for use in contacting at least one of medical equipment, medical device, surface in the medical industry, dental equipment, dental device, and surface in the dental industry.
[55.] The present invention also provides for the one part, liquid concentrate disinfectant of any one of the above embodiments, wherein:

(a) the hydrogen peroxide concentration is about 20.0-26.0 wt. %;

(b) the acetic acid concentration is about 9.0 to 11.0 wt. %;

(c) the Dequest® 2010 concentration is about 1.0 wt. %;

(d) the Pluronic® 10R5 surfactant block copolymer concentration is about 2.0 wt. %; and

(e) the peracetic acid concentration is about 6.0 to 7.1 wt. %.

[56.] The present invention also provides for a kit that includes:

(a) an enclosed container comprising a removable closure,

(b) the composition of any one of the above embodiments, located inside the enclosed container, and

(c) printed indicia located on the enclosed container.

[57.] The present invention also provides for the kit of the above embodiment, wherein the enclosed container is manufactured from high density polyethylene (HDPE).
[58.] The present invention also provides for the kit of any one of the above embodiments, wherein the enclosed container is opaque.
[59.] The present invention also provides for the kit of any one of the above embodiments, wherein the printed indicia comprises instructions to avoid excessive heat, to avoid elevated temperatures, to avoid direct sunlight, or a combination thereof.
[60.] The present invention also provides for the kit of any one of the above embodiments, wherein the enclosed container further comprises a head space.
[61.] The present invention also provides for the kit of any one of the above embodiments, wherein the enclosed container further comprises a head space, wherein the head space comprises oxygen (O2).
[62.] The present invention also provides for the kit of any one of the above embodiments, wherein the enclosed container further comprises a head space, present in up to about 5% (v/v) of the enclosed container.
[63.] The present invention also provides for the kit of any one of the above embodiments, wherein the removable closure of the enclosed container comprises a pressure valve, configured to release excessive gas from within the enclosed container.
[64.] The present invention also provides for the kit of any one of the above embodiments, further comprising a liquid applicator comprising at least one of a spray bottle, wipe, cloth, sponge, non-woven fabric, and woven fabric.
[65.] The present invention also provides for a method of reducing the number of microbes located upon a substrate, the method including contacting the substrate with an effective amount of the composition of any one of the above embodiments, for a sufficient period of time, effective to reduce the number of microbes located upon the substrate.
[66.] The present invention also provides for the method of the above embodiment, wherein the microbe or microorganism includes at least one of a virus, fungus, mold, slime mold, algae, yeast, mushroom and bacterium.
[67.] The present invention also provides for the method of any one of the above embodiments, wherein up to about 5 logs of desired microorganism is inactivated in about 5 minutes, or less. [68.] The present invention also provides for the method of any one of the above embodiments, wherein about 1 wt. % of the composition is employed, in combination with about 99 wt. % carrier.
[69.] The present invention also provides for the method of any one of the above embodiments, wherein about 1 wt. % of the composition is employed, in combination with about 99 wt. % water.
[70.] The present invention also provides for a method of killing or inhibiting a microorganism, the method including contacting the microorganism with an antimicrobially effective amount of the composition of any one of the above embodiments, for a sufficient period of time, effective to kill or inhibit the microorganism.
[71.] The present invention also provides for the method of disinfecting a substrate, the method including contacting the substrate with an effective amount of the composition of any one of the above embodiments, for a sufficient period of time, effective to disinfect the substrate.
[72.] The present invention also provides for the method of any one of the above embodiments, wherein the substrate to be contacted is a medical device.
[73.] The present invention also provides for the method of any one of the above embodiments, wherein the substrate to be contacted is a soiled endoscopic device.
[74.] The present invention also provides for the method of any one of the above embodiments, wherein the substrate to be contacted is cleaned prior to disinfecting.
[75.] The present invention also provides for a method of any one of the above embodiments, wherein the substrate to be contacted is a medical device, wherein the medical device is cleaned to remove foreign and fecal matter prior to disinfecting.
[76.] The present invention also provides for a method of any one of the above embodiments, wherein the substrate to be contacted is an endoscopic device, wherein the endoscopic device is cleaned to remove foreign and fecal matter prior to disinfecting.
[77.] The present invention also provides for a method of any one of the above embodiments, wherein the substrate to be contacted is a cleaned medical device.
[78.] The present invention also provides for a method of any one of the above embodiments, wherein the substrate to be contacted is a cleaned endoscopic device.

1. A composition comprising:
a. hydrogen peroxide;
b. organic acid;
c. chelator; and
d. surfactant,
wherein the composition comprises less than about 0.1 wt. % of an anticorrosive agent.

2. The composition of claim 1, wherein the composition further comprises peracetic acid.

3. The composition of claim 1, wherein the composition further comprises peracetic acid formed by the reaction of acetic acid with hydrogen peroxide.

4. The composition of claim 1, wherein the composition further comprises peracetic acid, present in about 5.0 wt. % to about 10.0 wt. % of the composition.

5. The composition of claim 1, wherein the balance (q.s.) of the composition is water.

6. The composition of claim 1, which is a liquid disinfectant.

7. The composition of claim 1, comprising less than about 0.1 wt. % buffer.

8. The composition of claim 1, wherein the hydrogen peroxide is present in about 10 wt. % to about 50 wt. % of the composition.

9. The composition of claim 1, wherein the organic acid comprises acetic acid.

10. The composition of claim 1, wherein the organic acid comprises acetic acid, present in at least about 3 wt. % of the composition.

11. The composition of claim 1, wherein the chelator comprises Dequest® 2010 (1-hydroxyethylidene-1,1,-diphosphonic acid, HEDP).

12. The composition of claim 1, wherein the chelator comprises Dequest® 2010 (1-hydroxyethylidene-1,1,-diphosphonic acid, HEDP), present in at least about 0.1 wt. % of the composition.

13. The composition of claim 1, wherein the surfactant comprises Pluronic® 10R5 surfactant block copolymer.

14. The composition of claim 1, wherein the surfactant comprises Pluronic® 10R5 surfactant block copolymer, present in at least about 0.1 wt. % of the composition.

15. A composition comprising:
a. hydrogen peroxide, present in a concentration of about 28 wt. %;
b. acetic acid, present in a concentration of about 16 wt. %;
c. Dequest® 2010, present in a concentration of about 1.0 wt. %; and
d. Pluronic® 10R5 surfactant block copolymer, present in a concentration of about 2.0 wt. %;
wherein the composition comprises less than about 0.1 wt % of an anticorrosive agent.

16. The composition of claim 15, wherein the balance (q.s.) of the composition is water.

17. The composition of claim 15, wherein the balance (q.s.) of the composition is deionized water.

18. The composition of claim 15, wherein the composition further comprises peracetic acid, present in about 6.8 wt. % to about 7.5 wt. % of the composition.

19. A composition comprising:
a. hydrogen peroxide, present in a concentration of about 20 wt. % to about 26.0 wt. %;
b. acetic acid, present in a concentration of about 9.0 to about 11.0 wt. %;
c. peracetic acid, present in about 6.8 wt. % to about 7.5 wt. % of the composition;
d. Dequest® 2010, present in a concentration of about 1.0 wt. %; and
e. Pluronic® 10R5 surfactant block copolymer, present in a concentration of about 2.0 wt. %;
wherein the composition comprises less than about 0.1 wt. % of an anticorrosive agent.

20. The composition of claim 19, wherein the balance (q.s.) of the composition is deionized water.

21. A method of reducing the number of microbes located upon a substrate, the method comprising contacting the substrate with an effective amount of a composition comprising:
a. hydrogen peroxide;
b. organic acid;
c. chelator; and
d. surfactant
wherein the composition comprises less than about 0.1 wt. % of an anticorrosive agent, for a sufficient period of time, effective to reduce the number of microbes located upon the substrate.

22. The method of claim 21, wherein the microbe or microorganism comprises at least one of a virus, fungus, mold, slime mold, algae, yeast, mushroom and bacterium.

23. The method of claim 21, wherein the substrate is a medical device.

24. The method of claim 21, wherein the substrate is an endoscope.

25. The method of claim 21, wherein up to about 7.12 logs of desired microorganism is inactivated in about 5 minutes, or less.

26. The method of claim 21, wherein up about 7.12 logs of Mycobacterium terrae is inactivated in about 5 minutes, or less.

27. The method of claim 21, wherein about 1 wt. % of the composition is employed, in combination with about 99 wt. % carrier.

28. The method of claim 21, wherein about 1 wt. % of the composition is employed, in combination with about 99 wt. % water.
